(19) United States
(12) Patent Application Publication
(10) Pub. No.: US 2012/0223926 A1
(43) Pub. Date: Sep. 6, 2012

(54) POWER-SUPPLY CIRCUIT AND LIQUID CRYSTAL DISPLAY DEVICE PROVIDED THEREWITH

(75) Inventors: Hideki Morii, Osaka-shi (JP); Akihisa Iwamoto, Osaka-shi (JP); Takayuki Mizunaga, Osaka-shi (JP); Kei Ikuta, Osaka-shi (JP)

(73) Assignee: SHARP KABUSHIKI KAISHA, Osaka-shi, Osaka (JP)

(21) Appl. No.: 13/504,964

(22) PCT Filed: Jul. 7, 2010
(86) PCT No.: PCT/JP2010/061515

§ 371 Date: Apr. 30, 2012

(30) Foreign Application Priority Data
Nov. 25, 2009 (JP) 2009-266969

(51) Int. Cl. G09G 5/00; G05F 1/46

(52) U.S. Cl. 345/209; 323/282; 345/96

(57) ABSTRACT

An object is to provide at low cost a Power-supply circuit that can generate positive and negative analog power source voltages of which absolute values of voltage values are equal.

A Power-supply circuit (210) is configured by a DCDC converter circuit (212) and a charge pump circuit (214). The charge pump circuit (214) includes a diode (D3) that passes a current when a control switch (51) is in an off state, and a diode (D4) that passes a current when the control switch (51) is in an on state. A DCDC converter circuit (212) includes two diodes (D1, D2) that pass a current when the control switch (S1) is in an off state. A rectifying unit that includes the diodes (D1, D2) is configured such that a forward drop voltage of the rectifying unit becomes equal to a sum of a forward drop voltage of the diode (D3) and a forward drop voltage of the diode (D4).

### TECHNICAL FIELD

The present invention relates to a power-supply circuit, and relates, more particularly, to a power-supply circuit suitable for a liquid crystal display device including a one-chip source driver.

### BACKGROUND ART

In general, an active matrix-type liquid crystal display device includes a liquid crystal panel made of two substrates that sandwich a liquid crystal layer. On one of the two substrates, a plurality of gate bus lines (scanning signal lines) and a plurality of source bus lines (video signal lines) are arranged in a lattice shape, and a plurality of pixel formation portions arranged in matrix respectively corresponding to intersections between the plurality of gate bus lines and the plurality of source bus lines are provided. Each pixel formation portion includes a thin-film transistor (TFT) which is a switching element having a gate terminal connected to a gate bus line passing through a corresponding intersection and having a source terminal connected to a source bus line passing through the intersection, and includes a pixel capacitance for holding a pixel value. A common electrode which is a counter electrode provided so as to be shared among the plurality of pixel formation portions are provided on the other of the two substrates. The active matrix-type liquid crystal display device further includes a gate driver (scanning signal line drive circuit) that drives the plurality of gate bus lines; and a source driver (video signal line drive circuit) that drives the plurality of source bus lines.

By the way, in general, the source driver is provided at a peripheral portion of a display unit in a mode of an IC (Integrated Circuit) chip. Conventionally, to secure a sufficient drive capability as a source driver, a liquid crystal display device includes a plurality of source drivers (IC chips) (a configuration that includes a plurality of IC chips is called a “multichip configuration”). However, in recent years, to make a liquid crystal display device compact, manufacturing of a source driver in one chip is being progressed. Further, liquid crystal display devices are increasingly employing a one-chip driver that accommodates not only the source driver but also a power-supply circuit and a timing controller in one IC chip.

Further, in recent years, in a liquid crystal display device that employs an a-Si TFT liquid crystal panel (a liquid crystal panel that uses amorphous silicon for a semiconductor layer of a thin-film transistor), providing gate drivers in a monolithic manner have become more common. Conventionally, in many cases, a gate driver is also provided at a peripheral portion of the display unit in a mode of an IC chip. However, in recent years, providing a gate driver directly on a substrate has gradually become popular. Such a gate driver is called a “monolithic gate driver” for example, and a panel that includes the monolithic gate driver is called a “gate driver monolithic panel” for example.

By the way, in a liquid crystal display device that employs a dot-reversal driving system (a driving system that reverses positive and negative polarities of a liquid crystal application voltage for each one frame in each pixel, while reversing the polarities for each pixel adjacent in vertical and horizontal directions) and a source-line reversal driving system (a driving system that reverses positive and negative polarities of a liquid crystal application voltage for each one frame in each source bus line, while reversing the polarities for each source bus line), a potential of a common electrode needs to be set constant. Therefore, an amplitude of a voltage that can be outputted from the source driver needs to be an amplitude that corresponds to equal to or larger than two times a maximum value of a liquid crystal application voltage. Therefore, in a liquid crystal display device in which a maximum value of a liquid crystal application voltage is 6 V, for example, a source driver that can have an amplitude of an output voltage of equal to or higher than 12 V is necessary. In this case, when the source driver is realized by a multichip configuration, a potential relationship of drive signals (a scanning signal VG and a video signal VS) becomes as shown in FIG. 10. Regarding the scanning signal VG, a gate-on voltage VGH is 24 V, and a gate-off voltage VGL is −7 V, in an example shown in FIG. 10. Regarding the video signal VS, a voltage varies within a range of 0 V to 12 V, in the example shown in FIG. 10. Thus, when the source driver is realized by a multichip configuration, it is sufficient that a positive power source voltage is generated as a power source voltage for driving the source driver, because it is sufficient that the video signal VS is changed within only a range of positive voltages.

Contrary to this, when the source driver is realized by a one-chip driver, a potential relationship of the drive signals (the scanning signal VG and the video signal VS) becomes as shown in FIG. 11. Regarding the scanning signal VG, the gate-on voltage VGH is 18 V, and the gate-off voltage VGL is −13 V, in an example shown in FIG. 11. Regarding the video signal VS, a voltage varies within a range of −6 V to 6 V, in the example shown in FIG. 11. Unlike a case where the source driver is realized by a multichip configuration, the video signal VS varies within a range of both positive voltages and negative voltages. The reason is as follows. In general, while a process withstanding voltage of a large driver is about 13.5 V, a process withstanding voltage of a one-chip driver is about 6.0 V to 6.5 V. Therefore, when only a positive power source voltage is used in a case where the source driver is realized by a one-chip driver, an amplitude of the video signal becomes about 6.0 V to 6.5V at maximum. This amplitude is insufficient in a liquid crystal display device that employs the dot-reversal driving system and the source-line reversal driving system. Therefore, a negative power source voltage becomes necessary, in addition to a positive power source voltage. Thus, in the liquid crystal display device that includes a one-chip source driver, it is necessary to generate positive and negative power source voltages as power source voltages for driving the source driver.

As a configuration for generating positive and negative power source voltages, the followings are known. FIG. 12 is a circuit diagram showing a conventional configuration example (hereinafter, referred to as a “first configuration example”) for generating positive and negative power source voltages. In the first configuration example, positive and negative power source voltages are generated by two DCDC converter circuits 712, 812. Specifically, by a power source voltage VCC being increased in one DCDC converter circuit 712, a positive power source voltage (hereinafter, referred to as a “positive-side analog power source voltage”, because this voltage is an analog voltage) AVDDP is generated. By the power source voltage VCC being decreased in the other DCDC converter circuit 812, a negative power source voltage (hereinafter, referred to as a “negative-side analog power source voltage”) AVDDM is generated. Operations of the DCDC converter circuits 712, 812 are conventionally well known, and therefore their detailed description is omitted.

FIG. 13 is a circuit diagram showing another conventional configuration example (hereinafter, referred to as a “second configuration example”) for generating positive and negative power source voltages. In the second configuration example, a power-supply circuit 910 that generates positive and negative power source voltages is configured by a DCDC converter circuit 912 and a charge pump circuit 914. At an outside of the power-supply circuit 910, a DCDC controller 920 for controlling an operation of the power-supply circuit 910 is provided. The DCDC converter circuit 912 includes a thin-film transistor S91 that functions as a control switch, a coil (inductor) L91, a diode (rectifying device) D91, a capacitor C91, and resistors R91, R92. Regarding the thin-film transistor S91, a gate terminal is connected to an output terminal OUT of the DCDC controller 920, a drain terminal is connected to a node A, and a source terminal is grounded. Regarding the coil L91, the power source voltage VCC is provided to one end, and the other end is connected to the node A. Regarding the diode D91, an anode is connected to the node A, and a cathode is connected to a node J. Regarding the capacitor C91, one end is connected to the node J, and the other end is grounded. Further, it is configured such that a voltage of the node J is outputted from the power-supply circuit 910 as the positive-side analog power source voltage AVDDP. Regarding the resistor R91, one end is connected to the node J, and the other end is connected to a node K. Regarding the resistor R92, one end is connected to the node K, and the other end is grounded. The resistors R91, R92 constitute a voltage dividing circuit that divides the positive-side analog power source voltage AVDDP.

As shown in FIG. 13, a feedback signal FB that indicates a voltage of the node K is provided to an input terminal IN of the DCDC controller 920. The DCDC controller 920 outputs a control signal CTL for controlling an operation of the control switch from the output terminal OUT, based on the feedback signal FB.

The charge pump circuit 914 includes capacitors C92, C93, and diodes D93, D94. Regarding the capacitor C92, one end is connected to the node A, and the other end is connected to a node P. Regarding the capacitor C93, one end is connected to a node Q, and the other end is grounded. Regarding the diode D93, an anode is connected to the node P, and a cathode is grounded. Regarding the diode D94, an anode is connected to the node Q, and a cathode is connected to the node P.

In the configuration described above, a signal that indicates a voltage of the node K, that is, a signal that indicates a voltage after voltage-dividing of the positive-side analog power source voltage AVDDP by the voltage dividing circuit, is applied to the DCDC controller 920 as the feedback signal FB. Then, the DCDC controller 920 outputs the control signal CTL such that the thin-film transistor S91 becomes in an on state, when a voltage indicated by the feedback signal FB is higher than a predetermined voltage, and outputs the control signal CTL such that the thin-film transistor S91 becomes in an off state, when a voltage indicated by the feedback signal FB is equal to or lower than a predetermined voltage. In the following description, it is assumed that a voltage of the node K becomes higher than the predetermined voltage when the positive-side analog power source voltage AVDDP is higher than 6.0 V, and that a voltage of the node K becomes equal to or lower than the predetermined voltage when the positive-side analog power source voltage AVDDP is equal to or lower than 6.0 V.

An operation of the power-supply circuit 910 is described next. Note that, the description is based on an assumption that a forward drop voltage (also referred to as “forward voltage drop”) of each of the diodes D91, D93, and D4 is 0.3 V.

First, when the control switch (thin-film transistor S91) is placed in an off state, counter electromotive force is generated in the coil L91, and a voltage of the node A becomes higher than the power source voltage VCC. Accordingly, the diode D91 becomes in an on state, a current flows between the node A and the node J, and a charge is accumulated in the capacitor C91. Since the configuration is such that the control switch (thin-film transistor S91) becomes in an off state when the positive-side analog power source voltage AVDDP becomes higher than 6.0 V, a charge is accumulated in the capacitor C91 such that a voltage of the node J becomes 6.0 V. When a current flows between the node A and the node J, a forward drop voltage of 0.3 V is generated in the diode D91. Therefore, a voltage of the node A becomes 6.3 V.

In this case, a temporary current flows in the capacitor C92, a voltage of the node P becomes high, the diode D93 becomes in an on state, and the diode D94 becomes in an off state. Accordingly, a charge is accumulated in the capacitor C92. Sincee a forward drop voltage of 0.3 V is generated in the diode D93, a voltage of the node P becomes 0.3 V, and a charge is accumulated in the capacitor C92 such that a voltage between the both ends of the capacitor C92 becomes (6.3 V−0.3 V=) 6.0 V.

When the control switch (thin-film transistor S91) is changed from an on state to an off state, a voltage of the node A becomes 0 V and thus the diode D91 becomes in an off state. According as a voltage of the node A falls from 6.3 V to 0 V, a voltage of the node P falls from 0.3 V to −6.0 V. Accordingly, the diode D93 becomes in an off state, the diode D94 becomes in an on state, and thus a current flows between the node Q and the node P and consequently a charge is accumulated in the capacitor C93. At this case, since a forward drop voltage of 0.3 V is generated in the diode D94, a voltage of the node Q becomes −5.7 V. That is, the negative-side analog power source voltage AVDDM becomes −5.7 V.

The DCDC controller 920 outputs the control signal CTL such that the control switch (thin-film transistor S91) repeatedly alternates an on state and an off state, based on the feedback signal FB. Accordingly, the power-supply circuit 910 generates the positive-side analog power source voltage AVDDP of 6.0 V, and the negative-side analog power source voltage AVDDM of −5.7 V.

Concerning the present invention, Japanese Patent Application Laid-open Publication No. H11-175028 discloses a configuration as shown in FIG. 14, as a configuration for generating positive and negative power.

### PRIOR ART DOCUMENT

### Patent Document

[Patent Document 1] Japanese Patent Application Laid-open Publication No. H11-175028

### SUMMARY OF THE INVENTION

### Problems to be Solved by the Invention

However, according to the first configuration example, cost becomes high because two DCDC converter circuits are necessary. According to the second configuration example, an absolute value of the negative-side analog power source voltage AVDDM is smaller than an absolute value of the positive-side analog power source voltage AVDDP, by a forward drop voltage of the diode. In the above example, while the positive-side analog power source voltage AVDDP is 6.0 V, the negative-side analog power source voltage AVDDM is −5.7 V. Therefore, a maximum value of a liquid crystal application voltage becomes ((6.0 V+5.7 V)/2=) 5.85 V. That is, a maximum value of a liquid crystal application voltage is smaller than a limit value of a process withstanding voltage of the one-chip driver. Accordingly, performance of a liquid crystal panel is not sufficiently exhibited in some cases.

An object of the present invention is to provide at low cost a power-supply circuit that can generate positive and negative analog power source voltages of which absolute values of voltage values are equal.

### Means for Solving the Problems

A first aspect of the present invention is directed to a Power-supply circuit, comprising:

a DC voltage conversion circuit including an inductor having one end connected to a power source voltage, a switching element switched between on and off states based on a control signal applied from an outside in order to change a voltage of the other end of the inductor, a first capacitor having one end grounded, and a rectifying unit which passes a current only from the other end side of the inductor to the other end side of the first capacitor, the DC voltage conversion circuit outputting a voltage of the other end of the first capacitor as a first voltage; and

a charge pump circuit including a second capacitor having one end connected to the other end of the inductor, a third capacitor having one end grounded, a third rectifying element having an anode connected to the other end of the second capacitor and having a cathode grounded, and a fourth rectifying element having an anode connected to the other end of the third capacitor and having a cathode connected to the other end of the second capacitor, the charge pump circuit outputting a voltage of the other end of the third capacitor as a second voltage, wherein

a forward drop voltage of the rectifying unit is equal to a sum of a forward drop voltage of the third rectifying element and a forward drop voltage of the fourth rectifying element.

According to a second aspect of the present invention, in the first aspect of the present invention,

the rectifying unit includes a first rectifying element having an anode connected to the other end of the inductor, and a second rectifying element having an anode connected to a cathode of the first rectifying element and having a cathode connected to the other end of the first capacitor.

According to a third aspect of the present invention, in the second aspect of the present invention, the rectifying unit is configured by a diode module that includes a diode as the first rectifying element and a diode as the second rectifying element.

According to a fourth aspect of the present invention, in the second aspect of the present invention,

a forward drop voltage of the first rectifying element, a forward drop voltage of the second rectifying element, a forward drop voltage of the third rectifying element, and a forward drop voltage of the fourth rectifying element are equal.

According to a fifth aspect of the present invention, in the first aspect of the present invention,

the third rectifying element and the fourth rectifying element are Schottky diodes, and

the rectifying unit is configured by one diode whose forward drop voltage is higher than that of the Schottky diodes.

A sixth aspect of the present invention is directed to a liquid crystal display device, comprising:

a display unit that displays an image; a plurality of video signal lines that are arranged in the display unit; and a driving unit that is configured by one integrated circuit chip which includes a video signal line driving circuit which drives the plurality of video signal lines by alternately applying a positive voltage and a negative voltage to each video signal line as a video signal, wherein

the driving unit includes the Power-supply circuit according to claim 1, and

the video signal line driving circuit generates the positive voltage from the first voltage, and generates the negative voltage from the second voltage.

### Effects of the Invention

According to the first aspect of the present invention, in the power-supply circuit including the DC voltage conversion circuit and the charge pump circuit, the charge pump circuit includes the third rectifying element that passes a current when the control switch is in an off state, and the fourth rectifying element that passes a current when the control switch is in an on state, in a similar manner to that of the conventional configuration. The DC voltage conversion circuit includes the rectifying unit that passes a current when the control switch is in an off state. The rectifying unit is configured to generate a forward drop voltage corresponding to a sum of a forward drop voltage of the third rectifying element and a forward drop voltage of the fourth rectifying element. Incidentally, when an amplitude of the first voltage is V1 and a forward drop voltage of the rectifying unit is Vfs, an amplitude Va of the other end of the inductor is expressed by the following Equation (1).

Va=V1+Vfs (1)

When an amplitude of a voltage of the other end of the inductor is Va, a forward drop voltage of the third rectifying element is Vf3, and a forward drop voltage of the fourth rectifying element is Vf4, an amplitude of a second voltage is expressed by the following Equation (2).

V2=Va−(Vf3+Vf4) (2)

The forward drop voltage Vfs of the rectifying unit is equal to a sum of the forward drop voltage Vf3 of the third rectifying element and the forward drop voltage Vf4 of the fourth rectifying element. Therefore, when the above Equation (1) is substituted into the above Equation (2), the following Equation (3) is established.

V2=V1 (3)

In this way, the amplitude of the second voltage becomes equal to the amplitude of the first voltage. That is, an absolute value of the positive-side power source voltage and an absolute value of the negative-side power source voltage become equal. Further, the charge pump circuit is employed as a constituent element for generating a power source voltage of one polarity. Based on the above, a power-supply circuit that can generate positive and negative power source voltages of which absolute values of voltage values are equal is realized at low cost. Moreover, high conversion efficiency can be obtained as compared with a configuration that includes two DCDC converter circuits, and power consumption is reduced.

According to the second aspect of the present invention, since the rectifying unit is realized by the two rectifying elements that are connected in series, effect similar to that in the first aspect of the present invention is obtained by an easy configuration.

According to the third aspect of the present invention, since the rectifying unit is realized by the diode module, effect similar to that in the first aspect of the present invention is obtained by an easy configuration.

According to the fourth aspect of the present invention, since it is sufficient to prepare the same kind of rectifying elements, its realization is facilitated.

According to the fifth aspect of the present invention, since the rectifying unit is realized by one diode, the number of necessary parts can be minimized.

According to the sixth aspect of the present invention, in the liquid crystal display device that includes the driving unit that is configured by one integrated circuit chip (what is called a one-chip driver), a liquid crystal application voltage can be increased to near a limit of a process withstanding voltage of a chip. Therefore, performance of a liquid crystal panel improves as compared with conventional art. Moreover, since the liquid crystal application voltage can be increased, the number of kinds of panels to which a one-chip driver can be applied increases.

### BRIEF DESCRIPTION OF THE DRAWINGS

FIG. 1 is a circuit diagram showing a configuration of a power-supply circuit according to an embodiment of the present invention.

FIG. 2 is a block diagram showing an overall configuration of a liquid crystal display device in the embodiment.

FIG. 3 is a diagram for describing a configuration of a pixel in the embodiment.

FIG. 4 is a block diagram for describing a configuration of a one-chip driver in the embodiment.

FIG. 5 is a diagram for describing a potential relationship in the embodiment.

FIG. 6 is a diagram showing on/off states of diodes when a control switch is placed in an off state in the embodiment.

FIG. 7 is a diagram showing on/off states of diodes when the control switch is placed in an on state in the embodiment.

FIG. 8 is a diagram showing a configuration using a diode module of four terminals in a modification of the embodiment.

FIG. 9 is a diagram showing a configuration using a diode module of three terminals in a modification of the embodiment.

FIG. 10 is a waveform diagram for describing a potential relationship of a drive signal in a liquid crystal display device in which a source driver is realized by a multichip configuration in a conventional example.

FIG. 11 is a waveform diagram for describing a potential relationship of a drive signal in a liquid crystal display device in which a source driver is realized by a one-chip driver in the conventional example.

FIG. 12 is a circuit diagram showing a conventional configuration example for generating positive and negative power source voltages.

FIG. 13 is a circuit diagram showing another conventional configuration example for generating positive and negative power source voltages.

FIG. 14 is a circuit diagram showing a configuration for generating positive and negative power source voltages disclosed in Japanese Patent Application Laid-open Publication No. H11-175028.

### MODE FOR CARRYING OUT THE INVENTION

An embodiment of the present invention is described next with reference to the accompanying drawings.

<1. Overall Configuration>

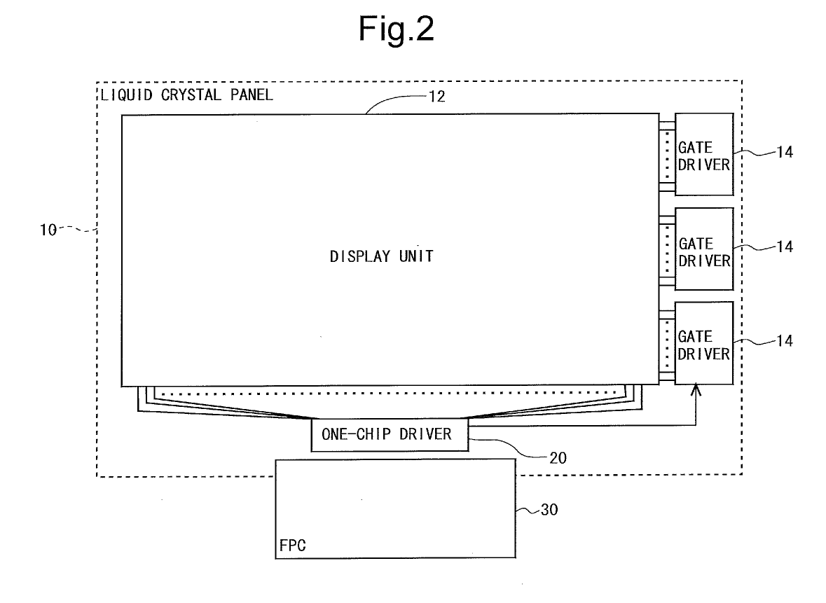

FIG. 2 is a block diagram showing an overall configuration of a liquid crystal display device according to the embodiment of the present invention. As shown in FIG. 2, the liquid crystal display device is configured by a liquid crystal panel 10, a one-chip driver 20 mounted on a substrate constituting the liquid crystal panel 10, and an FPC 30 connected to the substrate constituting the liquid crystal panel 10. The liquid crystal panel 10 includes a display unit 12. A plurality of gate drivers 14 for driving gate bus lines in the display unit 12 are monolithically formed on the substrate constituting the liquid crystal panel 10. Here, a source driver for driving source bus lines in the display unit 12 is formed in the one-chip driver 20. On the FPC 30, peripheral parts such as a capacitor, a resistor, a coil, a diode, and a thin-film transistor are mounted as constituent elements that are relevant to an operation of the one-chip driver 20.

As a driving system of the liquid crystal display device, a dot-reversal driving system and a source-line reversal driving system are employed. The dot-reversal driving system is a driving system that reverses positive and negative polarities of a liquid crystal application voltage for each one frame in each pixel while reversing the polarities for each pixel adjacent in vertical and horizontal directions. The source-line reversal driving system is a driving system that reverses positive and negative polarities of a liquid crystal application voltage, for each one frame in each source bus line while reversing the polarities for each source bus line.

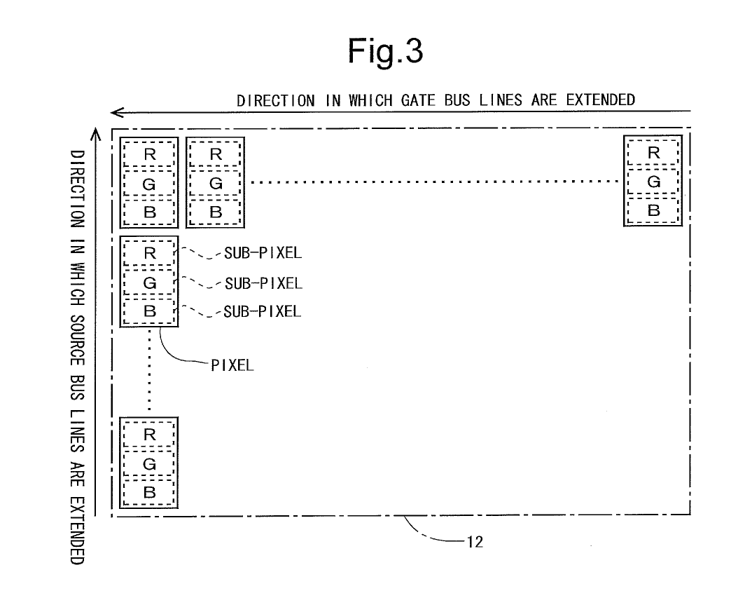

Incidentally, in the present embodiment, since the one-chip driver drives the source bus lines, it is preferable that the number of the source bus lines is as small as possible. Therefore, in the display unit 12, pixels are configured as shown in FIG. 3. This is described in detail. One pixel of an image that is displayed in the display unit 12 is configured by sub-pixels of a red color, a green color, and a blue color. In the present embodiment, the three sub-pixels are sequentially arranged in a direction in which the source bus lines are extended, as shown in FIG. 3. With this, when a WVGA panel (a panel with a pixel number of 800×480) is employed for the liquid crystal panel 10, for example, the display unit 12 internally includes 800 source bus lines and (480×3=) 1440 gate bus lines. Here, assuming that the three sub-pixels are sequentially arranged in a direction in which the gate bus lines are extended, the display unit 12 internally includes (800×3=) 2400 source bus lines and 480 gate bus lines. When the number of source bus lines that are included in the display unit 12 increases, it may be happen that the source bus lines cannot be driven by the one-chip driver 20. Therefore, in the present embodiment, as described above, the three sub-pixels are sequentially arranged in a direction in which the source bus lines are extended instead of a direction in which the gate bus lines are extended, and thus the source driver can be made in one chip. Note that the configuration of pixels shown in FIG. 3 is a preferable configuration example. However, depending on drive capability of the one-chip driver 20, the present invention can be also applied to a liquid crystal display device of a configuration in which the three sub-pixels are sequentially arranged in a direction in which the gate bus lines are extended. Also, a type of the liquid crystal panel 10 is not limited to the WVGA type.

<2. Configuration of “One-Chip Driver”>

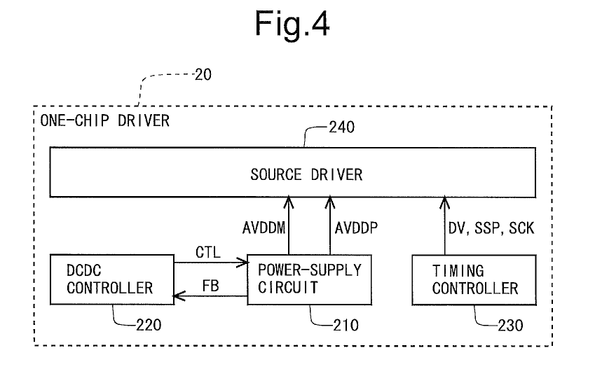

FIG. 4 is a block diagram for describing a configuration of the one-chip driver 20 in the present embodiment. The one-chip driver 20 includes a power-supply circuit 210, a DCDC controller 220, a timing controller 230, and a source driver 240. The power-supply circuit 210 generates the positive-side analog power source voltage AVDDP and the negative-side analog power source voltage AVDDM as voltages for driving the source driver 240, and outputs them. In this case, to stabilize the voltage values of the positive-side analog power source voltage AVDDP and the negative-side analog power source voltage AVDDM, the power-supply circuit 210 provides a feedback signal FB to the DCDC controller 220, and the DCDC controller 220 outputs the control signal CTL to control an operation of the power-supply circuit 210, based on the feedback signal FB. The timing controller 230 outputs a digital video signal DV, and a source start pulse signal SSP and a source clock signal SCK for controlling a timing of image display of the display unit 12. The source driver 240 outputs a video signal for driving, to the source bus lines, by using the positive-side analog power source voltage AVDDP and the negative-side analog power source voltage AVDDM that are outputted from the power-supply circuit 210, based on the digital video signal DV, the source start pulse signal SSP, and the source clock signal SCK that are outputted from the timing controller 230. Note that the video signal that is outputted from the source driver 240 is applied to the source bus lines, and an image is displayed on the display unit 12 based on the video signal.

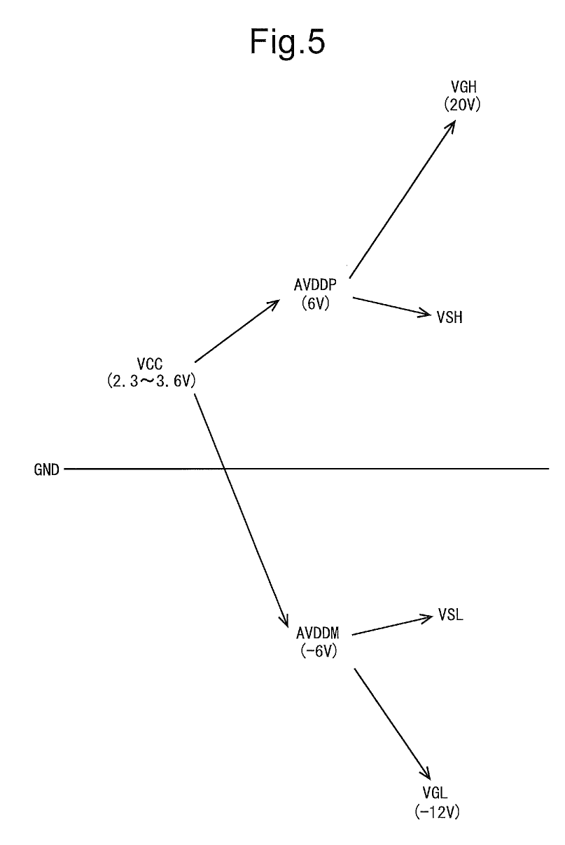

Here, a potential relationship in the present embodiment is described with reference to FIG. 5. A power source voltage VCC of 2.3 to 3.6 V is applied to the one-chip driver 20 from an external source. The power-supply circuit 210 generates the positive-side analog power source voltage AVDDP of 6.0 V and the negative-side analog power source voltage AVDDM of −6.0 V, by using the power source voltage VCC. The source driver 240 generates a positive-polarity video signal VSH having 6.0 V as a maximum value of a voltage, based on the positive-side analog power source voltage AVDDP, and generates a negative-polarity video signal VSL having 6.0 V as a maximum absolute value of a voltage, based on the negative-side analog power source voltage AVDDM. The gate-on voltage VGH of 20 V is generated by increasing the positive-side analog power source voltage AVDDP with a voltage increasing circuit or the like, and the gate-off voltage VGL of −12 V is generated by decreasing the negative-side analog power source voltage AVDDM with a voltage decreasing circuit or the like. Note that the specific voltage values are an example, and voltage values are not limited to these value.

<3. Configuration and Operation of Power-Supply Circuit>

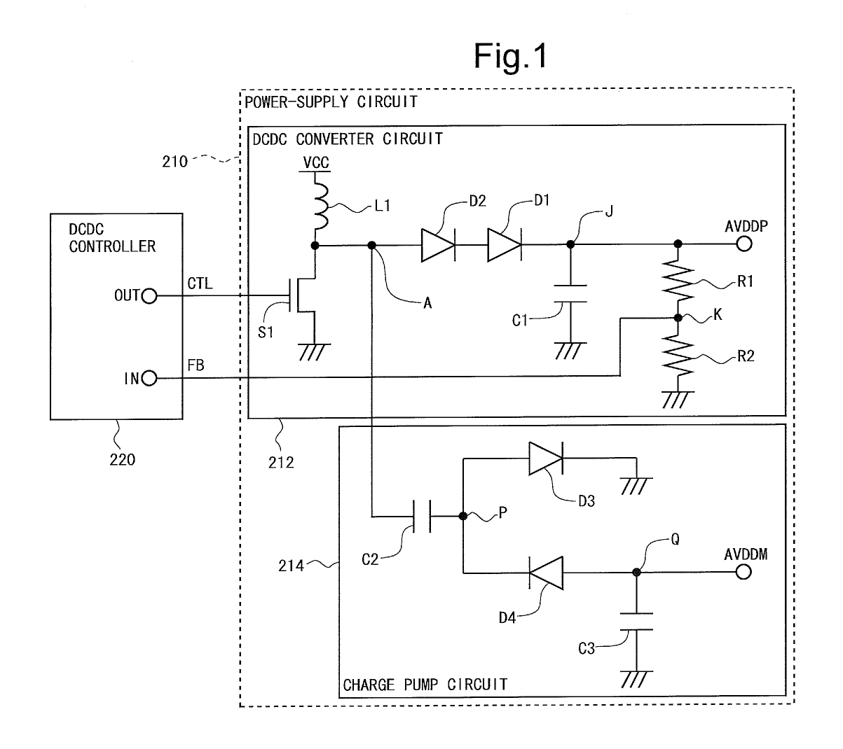

FIG. 1 is a circuit diagram showing a configuration of the power-supply circuit 210 in the present embodiment. Note that, as shown in FIG. 1, the feedback signal FB outputted from the power-supply circuit 210 is provided to the input terminal IN of the DCDC controller 220. The control signal CTL outputted from the output terminal OUT of the DCDC controller 220 is provided to the power-supply circuit 210.

The power-supply circuit 210 is configured by a DCDC converter circuit (DC voltage conversion circuit) 212, and a charge pump circuit 214. The DCDC converter circuit 212 includes a thin-film transistor S1 that functions as a control switch, a coil (inductor) L1, diodes (rectifying elements) D1, D2, a capacitor C1, and resistors R1, R2. Regarding the thin-film transistor S1, a gate terminal is connected to the output terminal OUT of the DCDC controller 220, a drain terminal is connected to a node A, and a source terminal is grounded. Regarding the coil L1, the power source voltage VCC is applied to one end, and the other end is connected to the node A. Regarding the diode D2, an anode is connected to the node A, and a cathode is connected to an anode of the diode D1. Regarding the diode D1, an anode is connected to a cathode of the diode D2, and a cathode is connected to anode J. Regarding the capacitor C1, one end is connected to the node J, and the other end is grounded. The configuration is such that a voltage of the node J is outputted from the power-supply circuit 210 as the positive-side analog power source voltage AVDDP. Regarding the resistor R1, one end is connected to the node J, and the other end is connected to a node K. Regarding the resistor R2, one end is connected to the node K, and the other end is grounded. The resistors R1, R2 constitute a voltage dividing circuit that divides the positive-side analog power source voltage AVDDP. Note that, in the present embodiment, a rectifying unit is realized by the diode D1 and the diode D2.

The charge pump circuit 214 includes capacitors C2, C3, and diodes D3, D4. Regarding the capacitor C2, one end is connected to the node A, and the other end is connected to a node P. Regarding the capacitor C3, one end is connected to a node Q, and the other end is grounded. Regarding the diode D3, an anode is connected to the node P, and a cathode is grounded. Regarding the diode D4, an anode is connected to the node Q, and a cathode is connected to the node P.

In a configuration described above, a signal that indicates a voltage of the node K, that is, a signal that indicates a voltage after voltage-dividing of the positive-side analog power source voltage AVDDP by the voltage dividing circuit, is provided to the DCDC controller 220 as the feedback signal FB. Then, the DCDC controller 220 outputs the control signal CTL such that the thin-film transistor S1 becomes in an on state, when a voltage that is indicated by the feedback signal FB is higher than a predetermined voltage, and outputs the control signal CTL such that the thin-film transistor Si becomes in an off state, when a voltage that is indicated by the feedback signal FB is equal to or lower than a predetermined voltage. Note that, in the present embodiment, it is assumed that a voltage of the node K becomes higher than the predetermined voltage when the positive-side analog power source voltage AVDDP is higher than 6.0 V, and that a voltage of the node K becomes equal to or lower than the predetermined voltage when the positive-side analog power source voltage AVDDP is equal to or lower than 6.0 V.

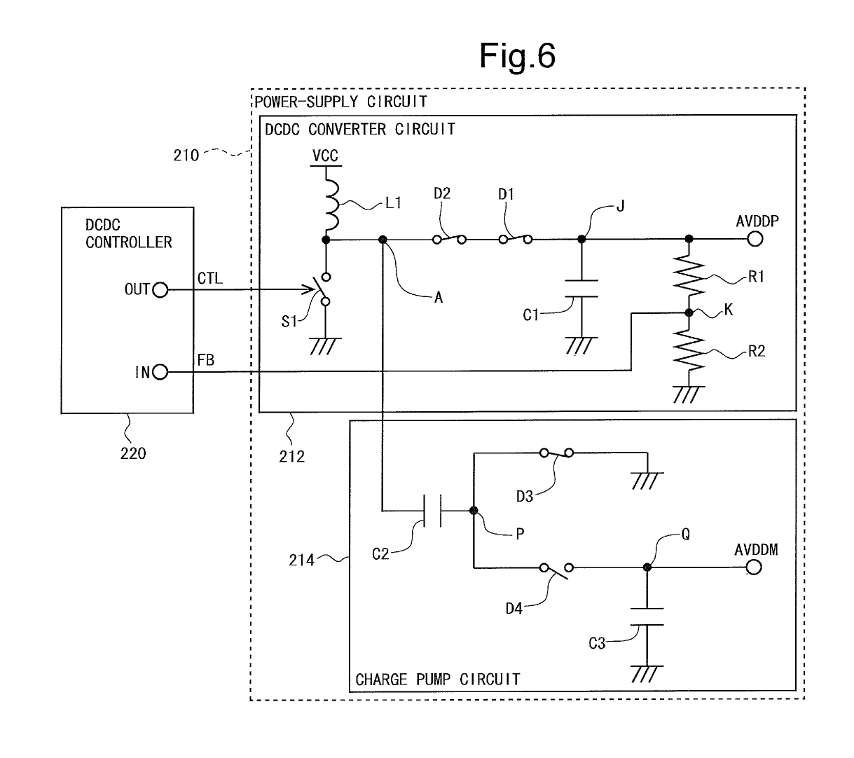

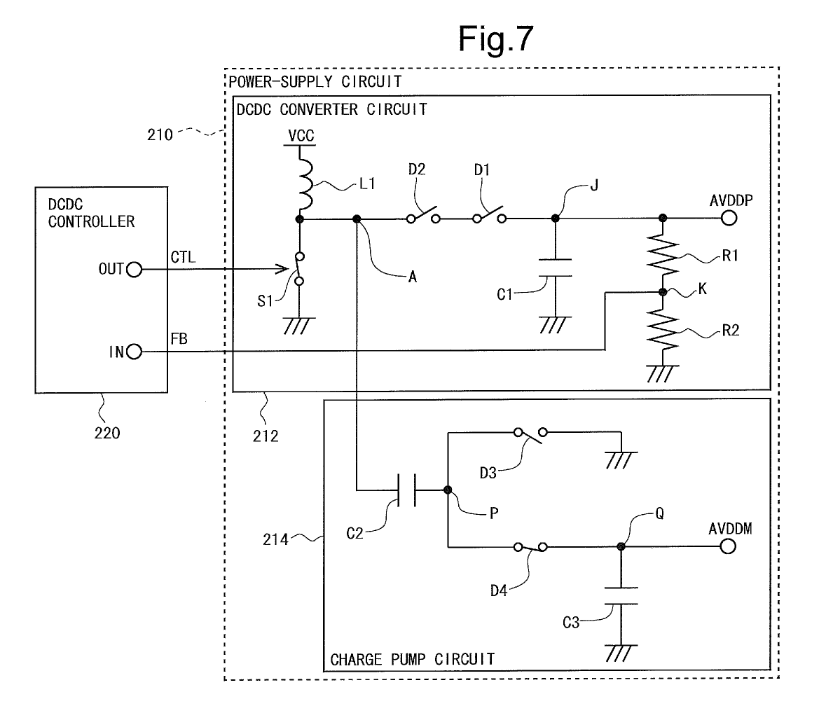

An operation of the power-supply circuit 210 is described next. Note that, FIG. 6 is a diagram showing on/off states of the diodes D1 to D4 when a control switch (thin-film transistor S1) is placed in an off state, and FIG. 7 is a diagram showing on/off states of the diodes D1 to D4 when the control switch (thin-film transistor S1) is placed in an on state. The description is based on an assumption that a forward drop voltage (also referred to as “forward voltage drop”) of each of the diodes D1 to D4 is 0.3 V.

First, when the control switch (thin-film transistor S1) is placed in an off state, counter electromotive force is generated in the coil L1, and a voltage of the node A becomes higher than the power source voltage VCC. Accordingly, both the diode D1 and the diode D2 become in an on state, a current flows between the node A and the node J, and a charge is accumulated in the capacitor C1. Since the configuration is such that the control switch (thin-film transistor S1) becomes in an off state when the positive-side analog power source voltage AVDDP becomes higher than 6.0 V, a charge is accumulated in the capacitor C1 such that a voltage of the node J becomes 6.0 V. When a current flows between the node A and the node J, a forward drop voltage of 0.3 V is generated in each of the diode D1 and the diode D2. Therefore, a voltage of the node A becomes 6.6 V.

In this case, a temporary current flows in the capacitor C2, a voltage of the node P becomes high, the diode D3 becomes in an on state, and the diode D4 becomes in an off state. Accordingly, a charge is accumulated in the capacitor C2. Since a forward drop voltage of 0.3V is generated in the diode D3, a voltage of the node P becomes 0.3V, and a charge is accumulated in the capacitor C2 such that a voltage between the both ends of the capacitor C2 becomes (6.6 V−0.3 V=) 6.3 V.

When the control switch (thin-film transistor S1) is changed from an on state to an off state, a voltage of the node A becomes 0 V and thus the diode D1 and the diode D2 become in an off state. According as a voltage of the node A falls from 6.6 V to 0 V, a voltage of the node P falls from 0.3 V to −6.3 V. Accordingly, the diode D3 becomes in an off state, the diode D4 becomes in an on state, and thus a current flows between the node Q and the node P and consequently a charge is accumulated in the capacitor C3. At this case, since a forward drop voltage of 0.3 V is generated in the diode D4, a voltage of the node Q becomes −6.0 V. That is, the negative-side analog power source voltage AVDDM becomes −6.0 V.

<4. Effect>

According to the present embodiment, the power-supply circuit 210 for generating positive and negative analog power source voltages is configured by the DCDC converter circuit 212 and the charge pump circuit 214. The DCDC converter circuit 212 includes two rectifier diodes, unlike the conventional configuration. Here, the four diodes D1 to D4 provided in the power-supply circuit 210 have equal forward drop voltages. When the forward drop voltage of the four diodes D1 to D4 is Vf and a voltage value of the positive-side analog power source voltage AVDDP is Vp, an amplitude of a voltage of the node A in the configuration shown in FIG. 1 becomes Vp+2×Vf. When the control switch S1 in the DCDC converter circuit 212 is in an off state, the diode D3 in the charge pump circuit 214 becomes in an on state. In this case, since the forward drop voltage Vf is generated in the diode D3, a charge is accumulated in the capacitor C2 such that a voltage between the both ends of the capacitor C2 becomes (Vp+2×Vf−Vf=) Vp+Vf. Then, when the control switch S1 in the DCDC converter circuit 212 changes from an off state to an on state, a voltage of the node P becomes (Vf−(Vp+2×Vf)=) −Vp−Vf in accordance with a fall of the voltage of the node A. Accordingly, the diode D3 becomes in an off state, and the diode D4 becomes in an on state. In this case, since the forward drop voltage Vf is generated in the diode D4, a voltage of the node Q becomes −Vp. In this way, an absolute value of the positive-side analog power source voltage AVDDP and an absolute value of the negative-side analog power source voltage AVDDM become equal. In the present embodiment, the power-supply circuit 210 is not configured by two DCDC converter circuits, but is configured by one DCDC converter circuit 212 and one charge pump circuit 214. As a result, a power-supply circuit that can generate positive and negative analog power source voltages of which absolute values of voltage values are equal can be realized at low cost.

Moreover, since the negative-side analog power source voltage AVDDM is generated by the charge pump circuit 214, higher conversion efficiency is obtained than that of a configuration that includes two DCDC converter circuits, and thus power consumption is reduced. Further, since a liquid crystal application voltage can be increased to substantially a limit value of a process withstanding voltage of the one-chip driver 20, performance of the liquid crystal panel improves. Further, since the liquid crystal application voltage can be increased as described above, the number of kinds of panels to which a one-chip driver can be applied increases as compared with the conventional art. For example, a one-chip driver can be applied to an ASV (Advanced Super View) panel as a panel having a broad view angle and satisfactory response.

<5. Modification>

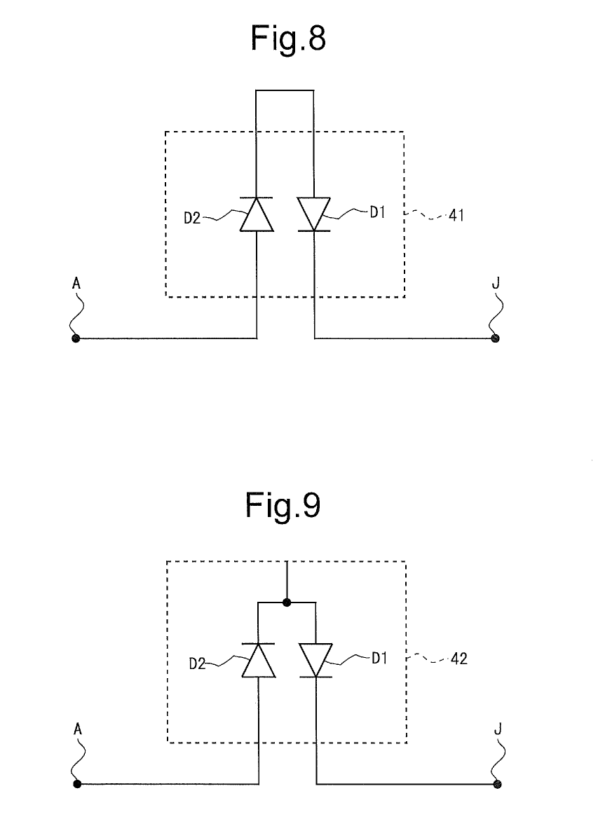

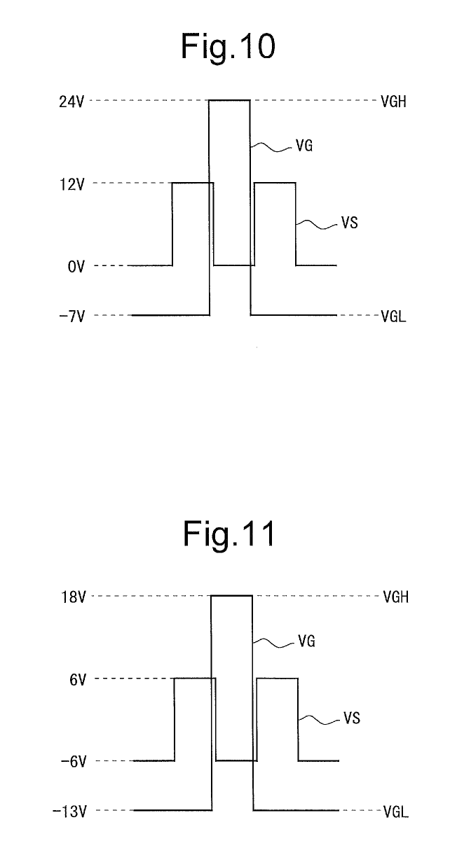

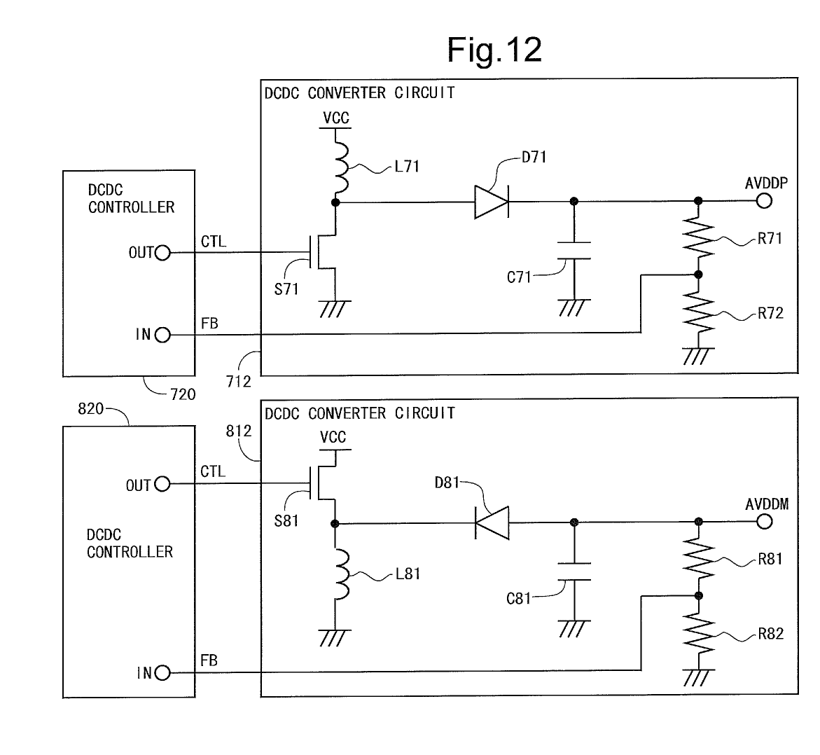

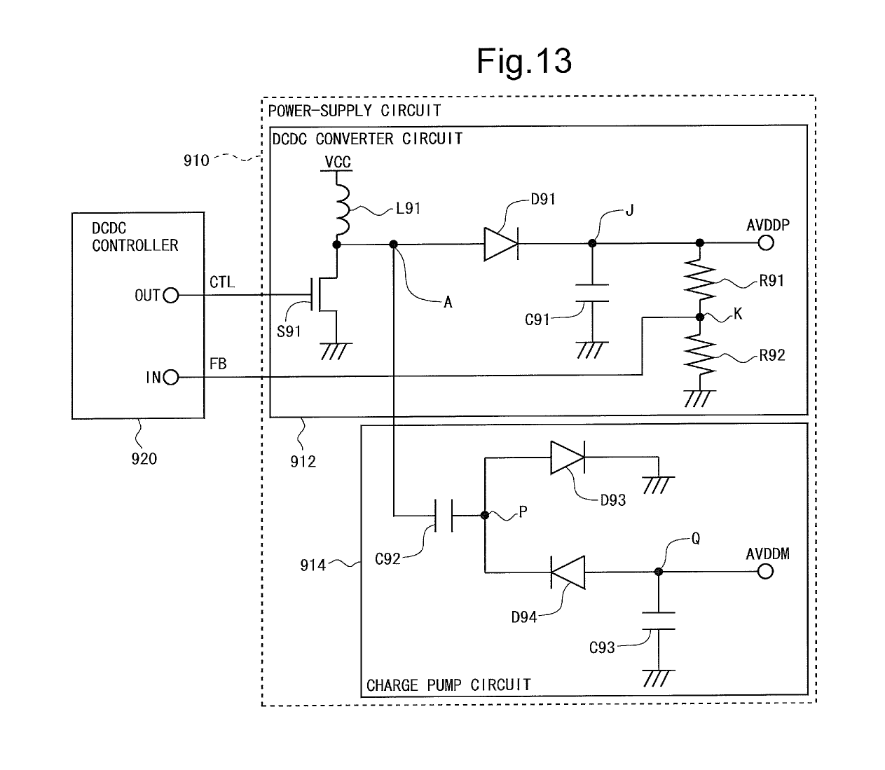

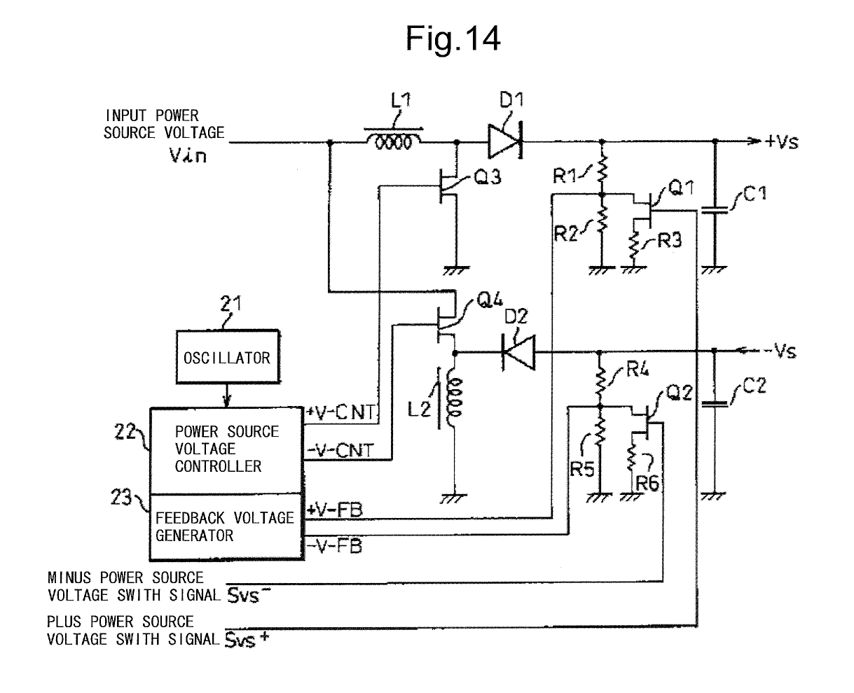

A diode provided between the node A and the node J of the DCDC converter circuit 212 may be also realized by a diode module including two diodes D2, D1. Concerning this, when a four-terminal diode module is employed, a configuration as shown in FIG. 8 is used, and when a three-terminal diode module is employed, a configuration as shown in FIG. 9 is used.

Although two diodes are provided between the node A and the node J in the DCDC converter circuit in the embodiment, the present invention is not limited to this. For example, a Schottky diode as a diode that has a relatively small forward drop voltage may be employed for the diodes D3, D4 in the charge pump circuit 214, and one diode that has a relatively large forward drop voltage may be employed in place of the diodes D1, D2 in the DCDC converter circuit 212.

### DESCRIPTION OF REFERENCE CHARACTERS

10 . . . Liquid crystal panel

12 . . . Display unit

14 . . . Gate driver

20 . . . One-chip driver

30 . . . FPC

210 . . . Power-supply circuit

212 . . . DCDC converter circuit

214 . . . Charge pump circuit

220 . . . DCDC controller

230 . . . Timing controller

240 . . . Source driver

AVDDP . . . Positive-side analog power source voltage

AVDDM . . . Negative-side analog power source voltage

C1 to C3 . . . Capacitor

D1 to D4 . . . Diode

L1 . . . Coil

R1, R2 . . . Resistor

1. A Power-supply circuit, comprising:
a DC voltage conversion circuit including an inductor having one end connected to a power source voltage, a switching element switched between on and off states based on a control signal applied from an outside in order to change a voltage of the other end of the inductor, a first capacitor having one end grounded, and a rectifying unit which passes a current only from the other end side of the inductor to the other end side of the first capacitor, the DC voltage conversion circuit outputting a voltage of the other end of the first capacitor as a first voltage; and
a charge pump circuit including a second capacitor having one end connected to the other end of the inductor, a third capacitor having one end grounded, a third rectifying element having an anode connected to the other end of the second capacitor and having a cathode grounded, and a fourth rectifying element having an anode connected to the other end of the third capacitor and having a cathode connected to the other end of the second capacitor, the charge pump circuit outputting a voltage of the other end of the third capacitor as a second voltage, wherein
a forward drop voltage of the rectifying unit is equal to a sum of a forward drop voltage of the third rectifying element and a forward drop voltage of the fourth rectifying element.

2. The Power-supply circuit according to claim 1, wherein
the rectifying unit includes a second rectifying element having an anode connected to the other end of the inductor, and a first rectifying element having an anode connected to a cathode of the second rectifying element and having a cathode connected to the other end of the first capacitor.

3. The Power-supply circuit according to claim 2, wherein
the rectifying unit is configured by a diode module that includes a diode as the first rectifying element and a diode as the second rectifying element.

4. The Power-supply circuit according to claim 2, wherein
a forward drop voltage of the first rectifying element, a forward drop voltage of the second rectifying element, a forward drop voltage of the third rectifying element, and a forward drop voltage of the fourth rectifying element are equal.

5. The Power-supply circuit according to claim 1, wherein
the third rectifying element and the fourth rectifying element are Schottky diodes, and
the rectifying unit is configured by one diode whose forward drop voltage is higher than that of the Schottky diodes.

6. A liquid crystal display device, comprising:
a display unit that displays an image; a plurality of video signal lines that are arranged in the display unit; and a driving unit that is configured by one integrated circuit chip which includes a video signal line driving circuit which drives the plurality of video signal lines by alternately applying a positive voltage and a negative voltage to each video signal line as a video signal, wherein
the driving unit includes the Power-supply circuit according to claim 1, and
the video signal line driving circuit generates the positive voltage from the first voltage, and generates the negative voltage from the second voltage.
